(19) United States
(12) Patent Application Publication
(10) Pub. No.: US 2025/0321155 A1
(43) Pub. Date: Oct. 16, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Yukihiro YANO, Tokyo (JP); Takahiro Kumura, Tokyo (JP); Kosuke Kinoshita, Tokyo (JP)

(73) Assignee: NEC Corporation, Tokyo (JP)

(21) Appl. No.: 19/171,589

(22) Filed: Apr. 7, 2025

(30) Foreign Application Priority Data
Apr. 12, 2024 (JP) 2024-064614

(51) Int. Cl. G01M 5/00; G01S 13/08

(52) U.S. Cl. CPC G01M 5/0091; G01M 5/0008; G01M 5/005; G01S 13/08

(57) ABSTRACT

An information processing apparatus includes; a data acquisition unit that acquires irradiation-direction displacement data that was generated by irradiating a target object with radio waves from a flying object and indicates an amount of displacement of the target object in an irradiation direction of the radio waves; a constraint condition calculation unit that, using a constraint condition defining a relationship between a specific parameter and an amount of displacement of the target object, calculates a set-direction displacement amount candidate that satisfies the constraint condition; a displacement calculation unit that calculates an irradiation-direction displacement data candidate by applying the set-direction displacement amount candidate to an expression showing a relationship between the irradiation-direction displacement data and the amount of displacement in the set direction; and a parameter update unit that updates the specific parameter using a difference between the irradiation-direction displacement data candidate and the irradiation-direction displacement data.

### CROSS-REFERENCE TO RELATED APPLICATIONA

This application is based upon and claims the benefit of priority from Japanese patent application No. 2024-064614, filed on Apr. 12, 2024, the disclosure of which is incorporated herein in its entirety by reference.

### BACKGROUND OF THE INVENTION

### 1. Field of the Invention

The present disclosure relates to an information processing apparatus and an information processing method for calculating displacement occurring in a structure, and further relates to a program for implementing the same.

### 2. Background Art

Infrastructure structures such as bridges generally have a limited lifespan, and in recent years, deterioration in many infrastructure structures has become a major social issue. Periodic inspection is important in maintaining and managing such infrastructure structures, and inspection is usually carried out manually. However, due to labor shortages, there are limitations to manual inspection, and therefore monitoring technologies that use various sensors have been attracting attention.

For example, in the case of bridges, bridge displacement analysis that uses satellite-based synthetic aperture radar (SAR) has been proposed. In bridge displacement analysis using satellite SAR, radio waves are emitted from a satellite toward a bridge at set intervals and the reflected waves are received. The phase difference between the reflected waves is then calculated by interference processing. This phase difference arises due to displacement that occurs in the bridge during the interval between radio wave emission. The phase difference is then converted into displacement using the wavelength of the radio waves.

However, the displacement calculated in the above-mentioned bridge displacement analysis is displacement in the line of sight between the ground and the satellite (hereinafter referred to as “LOS (Line Of Sight) displacement”). It is difficult to determine the direction and the magnitude of displacement that has actually occurred in the bridge from such LOS displacement. For this reason, displacement analysis that uses two artificial satellites in different orbits (2.5D analysis) has been proposed (see Non-Patent Document 1, for example).

In the displacement analysis disclosed in Non-Patent Document 1, the result of displacement analysis performed based on a northward orbit (ascending orbit) of a first satellite is combined with the result of displacement analysis performed based on a southward orbit (descending orbit) of a second satellite. Accordingly, the target displacement is resolved into quasi-east-west and quasi-up-down components.
Non-Patent Document 1: Satoshi Fujiwara et al., “2.5-D surface deformation of M6.1 earthquake near Mt Iwate detected by SAR interferometry”, Geophysical Research Letters, Vol. 27, No. 14, pp. 2049-2052 Jul. 15, 2000.

However, there is a problem in that there are very few cases where the same target is irradiated with radio waves from two different satellites. For this reason, the displacement analysis disclosed in Non-Patent Document 1 can be applied to only a very limited number of cases. Therefore, there is a need to specify the amount of displacement in the direction in which displacement has actually occurred in infrastructure structures such as bridges using only one satellite.

### SUMMARY OF INVENTION

An example object of the present disclosure is to enable calculation of an amount of displacement in a direction corresponding to the analysis target using only one flying object.

In order to achieve the above-described object, an information processing apparatus includes:
a data acquisition unit that acquires irradiation-direction displacement data that was generated by irradiating a target object with radio waves from a flying object and indicates an amount of displacement of the target object in an irradiation direction of the radio waves;
a constraint condition calculation unit that, using a constraint condition defining a relationship between a specific parameter and an amount of displacement of the target object in a set direction, calculates an amount of displacement of the target object that satisfies the constraint condition as a set-direction displacement amount candidate;
a displacement calculation unit that calculates an irradiation-direction displacement data candidate by applying the calculated set-direction displacement amount candidate to an expression showing a relationship between the irradiation-direction displacement data and the amount of displacement of the target object in the set direction; and
a parameter update unit that updates the specific parameter using a difference between the calculated irradiation-direction displacement data candidate and the acquired irradiation-direction displacement data.

In order to achieve the above-described object, an information processing method includes:
a data acquisition step of acquiring irradiation-direction displacement data that was generated by irradiating a target object with radio waves from a flying object and indicates an amount of displacement of the target object in an irradiation direction of the radio waves;
   a constraint condition calculation step of, using a constraint condition defining a relationship between a specific parameter and an amount of displacement of the target object in a set direction, calculating an amount of displacement of the target object that satisfies the constraint condition as a set-direction displacement amount candidate;
   a displacement calculation step of calculating an irradiation-direction displacement data candidate by applying the calculated set-direction displacement amount candidate to an expression showing a relationship between the irradiation-direction displacement data and the amount of displacement of the target object in the set direction; and
   a parameter update step of updating the specific parameter using a difference between the calculated irradiation-direction displacement data candidate and the acquired irradiation-direction displacement data.

In order to achieve the above-described object, a computer readable recording medium according to an example aspect of the invention is a computer readable recording medium that includes recorded thereon a program,
the program including instructions that cause a computer to carry out:
a data acquisition step of acquiring irradiation-direction displacement data that was generated by irradiating a target object with radio waves from a flying object and indicates an amount of displacement of the target object in an irradiation direction of the radio waves;
a constraint condition calculation step of, using a constraint condition defining a relationship between a specific parameter and an amount of displacement of the target object in a set direction, calculating an amount of displacement of the target object that satisfies the constraint condition as a set-direction displacement amount candidate;
a displacement calculation step of calculating an irradiation-direction displacement data candidate by applying the calculated set-direction displacement amount candidate to an expression showing a relationship between the irradiation-direction displacement data and the amount of displacement of the target object in the set direction; and
a parameter update step of updating the specific parameter using a difference between the calculated irradiation-direction displacement data candidate and the acquired irradiation-direction displacement data.

As described above, according to the invention, it is possible to enable calculation of an amount of displacement in a direction corresponding to the analysis target using only one flying object.

### BRIEF DESCRIPTION OF THE DRAWINGS

FIG. 1 is a diagram illustrating a schematic configuration of an example of the information processing apparatus.

FIG. 2 is a diagram showing a more detailed configuration of the example of the information processing apparatus.

FIG. 3 is a diagram showing the target object and reflection points for which irradiation-direction displacement data is generated.

FIG. 4 is a diagram showing an example of irradiation-direction displacement data measured by a satellite.

FIG. 5 is a diagram for describing the constraint condition when the target object is a bridge.

FIG. 6 is a diagram showing the relationship between the LOS displacement and the set direction of the target object.

FIG. 7 is a flowchart illustrating an example of operation of the information processing apparatus.

FIG. 8 is a block diagram illustrating an example of a computer that realizes the information processing apparatus.

### EXAMPLE EMBODIMENT

### Example Embodiment

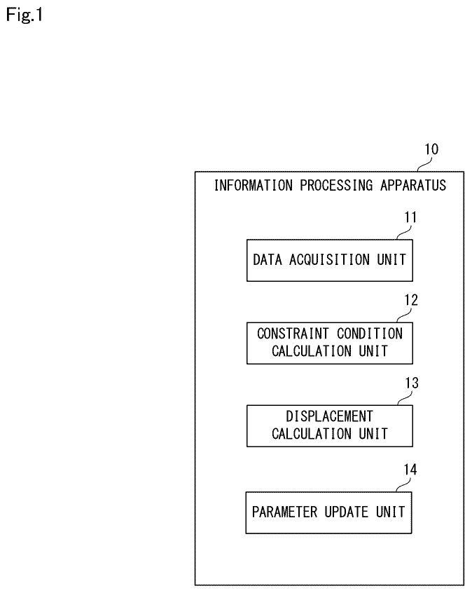

Hereinafter, an information processing apparatus, an information processing method, and a program will be described using example embodiments with reference to FIGS. 1 to 8.

### [Apparatus Configuration]

First, a schematic configuration of an example of an information processing apparatus will be described with reference to FIG. 1. FIG. 1 is a diagram illustrating a schematic configuration of an example of the information processing apparatus.

An information processing apparatus 10 shown in FIG. 1 is an apparatus for calculating displacement occurring in a target object. As shown in FIG. 1, the information processing apparatus 10 includes a data acquisition unit 11, a constraint condition calculation unit 12, a displacement calculation unit 13, and a parameter update unit 14.

The data acquisition unit 11 acquires irradiation-direction displacement data that was generated by irradiating a target object with radio waves from a flying object and indicates the amount of displacement of the target object in the irradiation direction. Here, one example of the flying object is a satellite. The flying object may be an object other than a satellite, such as an aircraft (manned or unmanned), an airship, or a balloon.

The constraint condition calculation unit 12 uses a constraint condition, which defines the relationship between the amount of displacement of the target object in a set direction and a specific parameter, to calculate a “set-direction displacement amount candidate” for an amount of displacement of the target object in the set direction that satisfies the constraint condition. The displacement calculation unit 13 applies the calculated set-direction displacement amount candidate to an expression indicating the relationship between the irradiation-direction displacement data and the amount of displacement of the target object in the set direction, to calculate provisional irradiation-direction displacement data (hereinafter referred to as an “irradiation-direction displacement data candidate”). The parameter update unit 14 updates the specific parameter by using the difference between the calculated irradiation-direction displacement data candidate and the acquired irradiation-direction displacement data.

Specifically, the information processing apparatus 10 calculates an irradiation-direction displacement data candidate using the amount of displacement obtained from the specific parameter, and calculates the difference between the calculated candidate and observed irradiation-direction displacement data. If the difference is large, the information processing apparatus 10 updates the parameter and brings the irradiation-direction displacement data candidate closer to the observed irradiation-direction displacement data. As a result, the set-direction displacement amount candidate approaches the actual displacement amount of the target object, and the set-direction displacement amount candidate with the smallest difference is output as the amount of displacement of the target object. In this way, the information processing apparatus 10 can calculate the amount of displacement in a direction corresponding to the analysis target by using only irradiation-direction displacement data observed by one flying object.

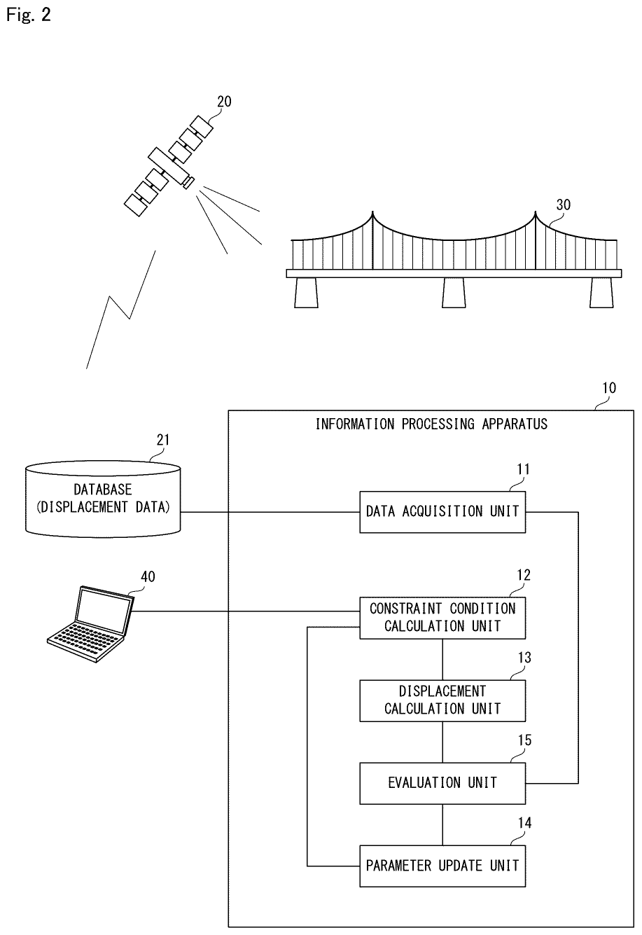

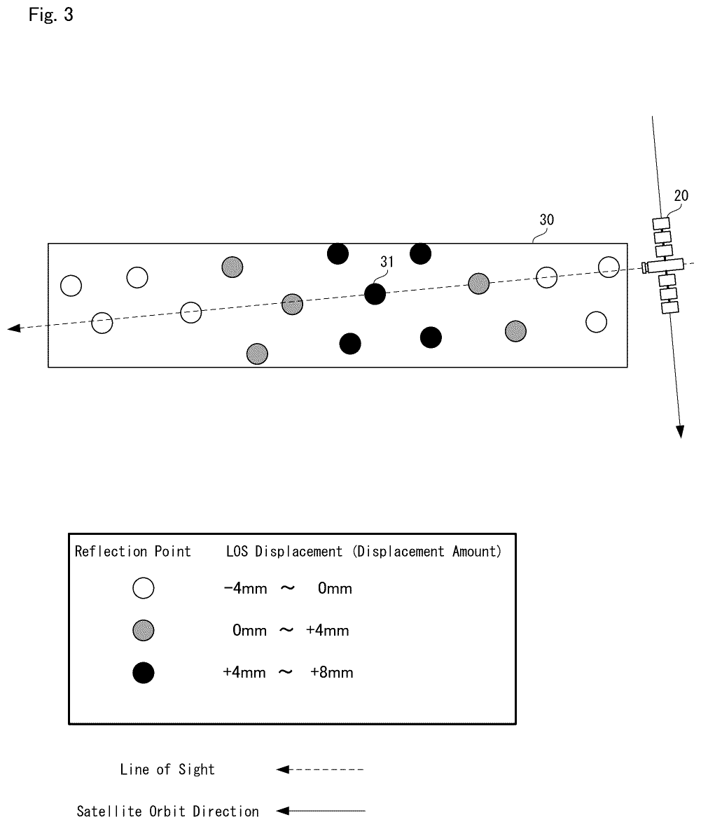

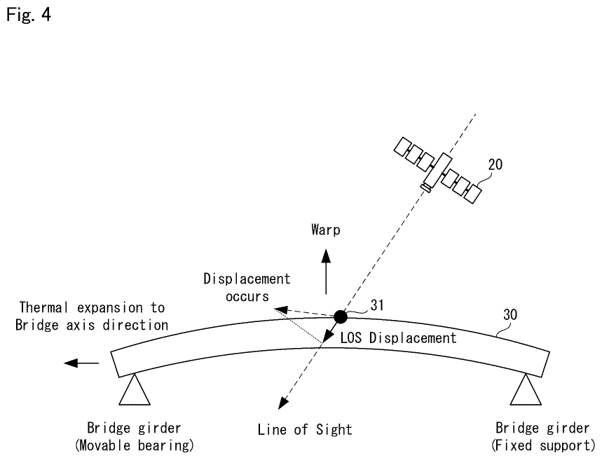

Next, the configuration and functions of the information processing apparatus 10 will be described in detail with reference to FIGS. 2 to 6. FIG. 2 is a diagram showing a more detailed configuration of the example of the information processing apparatus. FIG. 3 is a diagram showing the target object and reflection points for which irradiation-direction displacement data is generated. FIG. 4 is a diagram showing an example of irradiation-direction displacement data measured by a satellite.

As shown in FIG. 2, the information processing apparatus 10 includes an evaluation unit 15 in addition to the data acquisition unit 11, the constraint condition calculation unit 12, the displacement calculation unit 13, and the parameter update unit 14 described above. In the following description, it is assumed that the flying object is a satellite 20 and the target object is a bridge 30. Also, set directions of the target object include the bridge axis direction (x direction) of the bridge 30 and the vertical direction (z direction).

As shown in FIG. 3, the irradiation-direction displacement data transmitted from the satellite 20 is LOS displacement data for each of a plurality of reflection points 31 analyzed by satellite SAR. In FIG. 3, the dashed arrow indicates the direction of emission of radio waves from the satellite 20, and the solid arrow indicates the orbit of the satellite 20.

As shown in FIG. 4, LOS displacement is displacement in the line of sight of the satellite (irradiation direction). On the other hand, the displacement that is to be calculated is displacement in the bridge axis direction of the bridge 30 and displacement in the vertical direction, as will be described later. Also, in FIG. 4, the bridge is shown as a model. In the example in FIG. 4, the bridge has deformed due to thermal expansion, and therefore displacement has occurred. Note that a bridge can also deform due to a factor other than thermal expansion, such as the weight of passing vehicles.

The satellite 20 transmits irradiation-direction displacement data at a set date and time or periodically. The irradiation-direction displacement data received at the base station is stored in a database 21. Moreover, each piece of the irradiation-direction displacement data has an observation time, and the accumulated irradiation-direction displacement data is time-series data.

In the present example embodiment, the data acquisition unit 11 acquires irradiation-direction displacement data for each of a plurality of reflection points on the bridge 30 from the database 21. In this way, since the irradiation-direction displacement data is acquired for each reflection point, the processing performed by the constraint condition calculation unit 12, the displacement calculation unit 13, and the evaluation unit 15 is performed for each reflection point.

The constraint condition calculation unit 12 calculates set-direction displacement amount candidates dx′ and dz′ for an amount of displacement dx in the bridge axis direction of the bridge 30 and an amount of displacement dz in the vertical direction, respectively, using the constraint condition shown in, for example, Expression 1 below. In Expression 1 below, C represents the specific parameter.

$$f ( dx , dz , C ) = 0 \qquad [ Expression 1 ]$$

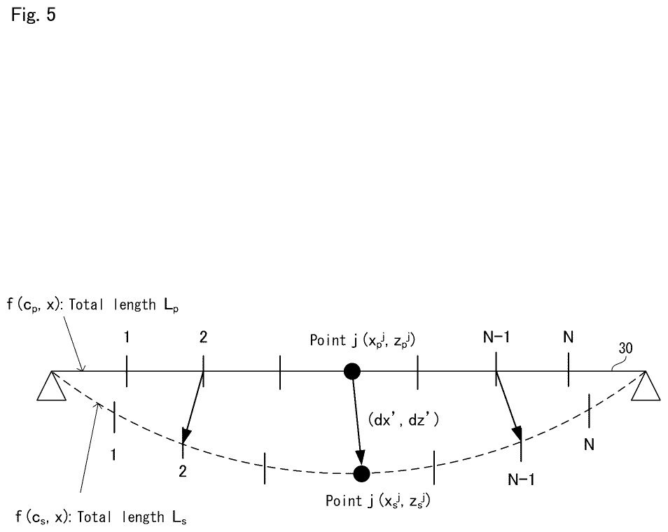

The following describes the constraint condition in detail. The constraint condition indicated by Expression 1 above is specifically set according to the target object. FIG. 5 is a diagram for describing the constraint condition when the target object is a bridge. Displacement that has occurred in the bridge 30 can be represented by the model shown in FIG. 5. The model shown in FIG. 5 is a finite element model of the bridge 30.

In the finite element model, the bridge 30 is decomposed into finite elements, and the amount of displacement for each set point (1 to N) is determined by executing simulation. In this case, using a specific parameter c, the modeled bridge shown in FIG. 5 is approximated by the curve shown in Expression 2 below. In this case, as shown in FIG. 5, the specific parameter c has a pre-deformation value cₚ and a post-deformation value cₛ, but since the pre-deformation parameter can always be deemed to be the same, the post-deformation specific parameter cₛ is updated.

$$f ( c , x ) = c x ( L - x ) \qquad [ Expression 2 ]$$

Also, other examples of the constraint conditions include Expressions 3 and 4 shown below

$$f ( c , x ) = {c}_{0} + {c}_{1} x + {c}_{2} {x}^{2} + … \qquad [ Expression 3 ]$$

$$f ( c , x ) = {c}_{0} * sin {c}_{1} x \qquad [ Expression 4 ]$$

Next, the following describes calculation of a set-direction displacement amount candidate dx′^{j} in the bridge axis direction and a set-direction displacement amount candidate dz′^{j} in the vertical direction at a set point j in the model shown in FIG. 5. Here, j is a value in the range of 1 to N, inclusive.

First, the coordinates (xₚ^{j}, zₚ^{j}) of the set point j before deformation satisfy Expressions 5 and 6 shown below, and therefore can be obtained from Expressions 5 and 6. Here, Lₚ indicates the total curve length of the bridge before deformation.

$$\frac{{L}_{p}}{N} = {\int }_{{x}_{p}^{j - 1}}^{{x}_{p}^{j}} \sqrt{1 + {( \frac{d}{d q} \{ f ( {c}_{p} , q ) \} )}^{2}} dq \qquad [ Expression 5 ]$$

$${z}_{p}^{j} = f ( {c}_{p} , {x}_{p}^{j} ) \qquad [ Expression 6 ]$$

Similarly, the coordinates (xₛ^{j}, zₛ^{j}) of the set point j after deformation satisfy Expressions 7 and 8 shown below, and therefore can be obtained from Expressions 7 and 8. Here, Lₚ indicates the total curve length of the bridge after deformation.

$$\frac{{L}_{s}}{N} = {\int }_{{x}_{s}^{j - 1}}^{{x}_{s}^{j}} \sqrt{1 + {( \frac{d}{d q} \{ f ( {c}_{s} , q ) \} )}^{2}} dq \qquad [ Expression 7 ]$$

$${z}_{s}^{j} = f ( {c}_{s} , {x}_{s}^{j} ) \qquad [ Expression 8 ]$$

In this way, the coordinates (xₚ^{j}, zₚ^{j}) of the set point j before deformation and the coordinates (xₛ^{j}, zₛ^{j}) of the set point j after deformation are obtained. Therefore, the set-direction displacement amount candidate dx′^{j} in the bridge axis direction and the set-direction displacement amount candidate dz′^{j} in the vertical direction at the set point j are calculated by Expression 9 shown below.

$$( {dx}^{′ j} , {dz}^{′ j} ) = ( {x}_{s}^{j} , {z}_{s}^{j} ) - ( {x}_{p}^{j} , {z}_{p}^{j} ) \qquad [ Expression 9 ]$$

In the present example embodiment, for each reflection point, the constraint condition calculation unit 12 calculates the set-direction displacement amount candidate dx′ in the bridge axis direction and the set-direction displacement amount candidate dz′ in the vertical direction, by the above-mentioned method.

In the present example embodiment, for each reflection point, the displacement calculation unit 13 applies the set-direction displacement amount candidates dx′ and dz′ calculated by the constraint condition calculation unit 12 to Expression 10 shown below to calculate an irradiation-direction displacement data candidate. Here, the irradiation-direction displacement data candidate is irradiation-direction displacement data indicating a provisional amount of displacement d′ₗₒₛ in the LOS displacement direction. In other words, the displacement calculation unit 13 back-calculates the LOS displacement from the set-direction displacement amount candidates.

$${d}_{LOS}^{′} = {dz}^{′} cos θ + {dx}^{′} sin θcos α \qquad [ Expression 10 ]$$

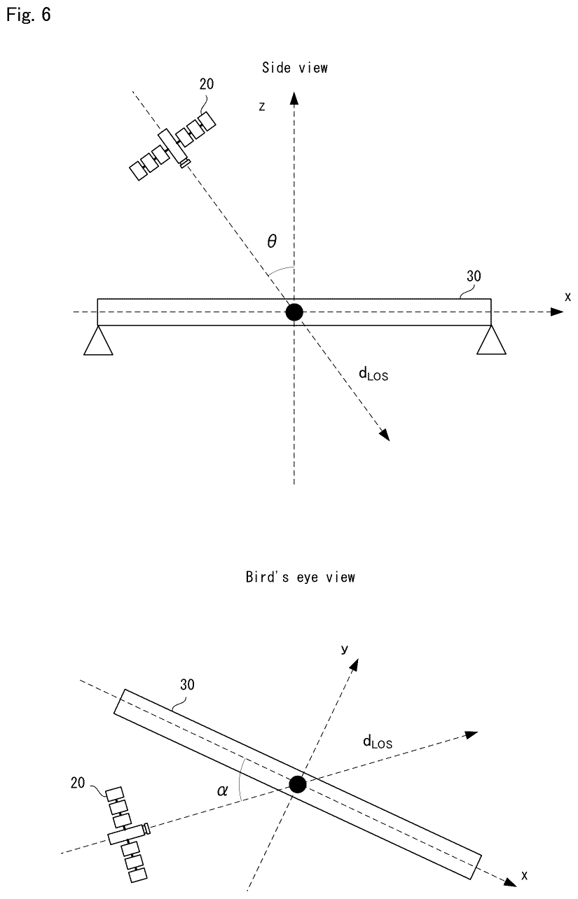

FIG. 6 is a diagram showing the relationship between the LOS displacement and the set direction of the target object. As shown in FIG. 6, θ shown in Expression 10 is the angle between the line of sight of the satellite 20 and the vertical direction, on the zx plane. Also, a shown in Expression 10 is the angle between the line of sight of the satellite 20 and the bridge axis direction, on the xy plane.

The evaluation unit 15 evaluates the difference between the irradiation-direction displacement data candidate calculated by the displacement calculation unit 13 and the observed irradiation-direction displacement data. Specifically, the evaluation unit 15 calculates the difference between the provisional displacement amount d′ₗₒₛ indicated by the irradiation-direction displacement data candidate and an amount of displacement dos indicated by the observed irradiation-direction displacement data.

As described above, the irradiation-direction displacement data is acquired for each reflection point, and the irradiation-direction displacement data candidate is calculated for each reflection point, and therefore the evaluation unit 15 calculates the difference for each reflection point. The evaluation unit 15 then further calculates a squared error or a likelihood using the difference calculated for the corresponding reflection point, and sets the calculated squared error or likelihood as an evaluation value. Thereafter, the evaluation unit 15 passes the calculated evaluation value to the parameter update unit 14.

The parameter update unit 14 determines whether or not the evaluation performed by the evaluation unit 15 satisfies a set condition. If the set condition is not satisfied, the parameter update unit 14 updates the parameter.

On the other hand, if the set condition is satisfied, the parameter update unit 14 causes the constraint condition calculation unit 12 to output the most recent set-direction displacement amount candidates dx′ and dz′ as the amounts of displacement dx and dz of the bridge 30. The output destination may be a terminal device 40 of, for example, a manager of the bridge 30.

Specifically, if the evaluation value is a squared error, the parameter update unit 14 determines, as the set condition, whether or not the value of the squared error is a threshold value or higher. If the result of the determination is that the value of the squared error is the threshold value or higher, the parameter update unit 14 updates the post-deformation specific parameter cₛ such that the value of the squared error decreases.

Furthermore, if the evaluation value is a likelihood, the parameter update unit 14 determines, as the set condition, whether or not the likelihood is a threshold value or lower. If the result of the determination is that the value of the likelihood is the threshold value or lower, the parameter update unit 14 updates the post-deformation specific parameter cₛ such that the likelihood increases.

The parameter update unit 14 can also update the parameter using an existing optimization method, such as a particle swarm optimization method (PSO) or a Markov chain Monte Carlo method (MCMC).

If the specific parameter has been updated by the parameter update unit 14, the constraint condition calculation unit 12, the displacement calculation unit 13, and the evaluation unit 15 execute processing again using the most recent updated specific parameter.

### [Apparatus Operation]

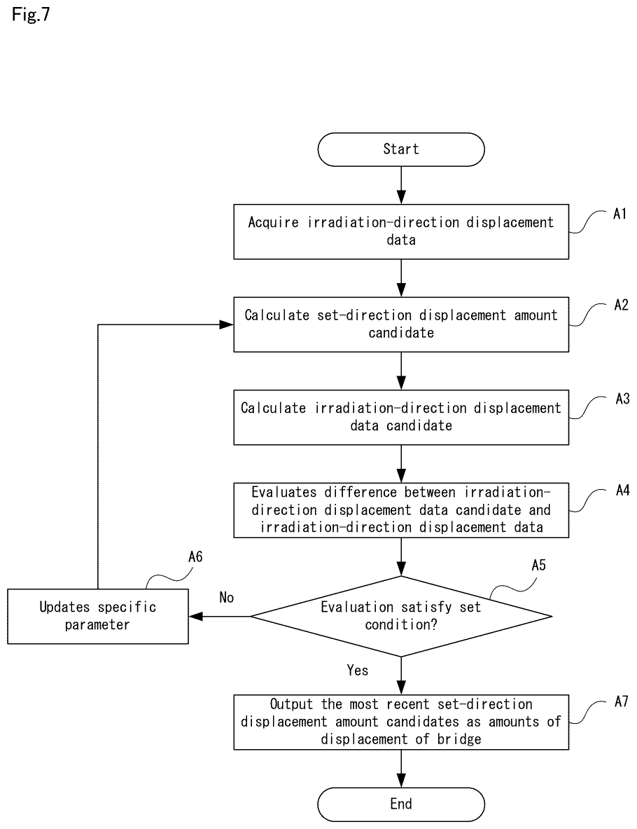

Next, operation of the information processing apparatus 10 will be described with reference to FIG. 7. FIG. 7 is a flowchart illustrating an example of operation of the information processing apparatus. In the following description, FIGS. 1 to 6 will be referred to as appropriate. Furthermore, an information processing method is implemented by causing the information processing apparatus 10 to operate. Therefore, in the present example embodiment, the following description of operation of the information processing apparatus 10 substitutes for a description of the information processing method.

As shown in FIG. 7, first, the data acquisition unit 11 acquires, from the database 21, irradiation-direction displacement data that was generated by irradiating the bridge 30 with radio waves from the satellite 20 and indicates an amount of displacement of the bridge 30 in the irradiation direction (step A1).

Next, the constraint condition calculation unit 12 calculates set-direction displacement amount candidates for amounts of displacement of the bridge 30 in the bridge axis direction and the vertical direction using a constraint condition that defines the relationship between a specific parameter and amounts of displacement of the bridge 30 in the bridge axis direction and the vertical direction (step A2).

Next, the displacement calculation unit 13 calculates an irradiation-direction displacement data candidate by applying the set-direction displacement amount candidates calculated in step A2 to an expression showing the relationship between the irradiation-direction displacement data and the amounts of displacement of the bridge 30 in the bridge axis direction and the vertical direction (step A3).

Next, the evaluation unit 15 evaluates the difference between the irradiation-direction displacement data candidate calculated in step A3 and the irradiation-direction displacement data acquired in step A1 (step A4).

Next, the parameter update unit 14 determines whether or not the evaluation in step A4 satisfies a set condition (step A5)).

If the result of the determination in step A5 is that the evaluation in step A4 does not satisfy the set condition, the parameter update unit 14 updates the specific parameter (step A6).

Then, step A2 is executed again.

On the other hand, if the result of the determination in step A5 is that the evaluation in step A4 satisfies the set condition, the parameter update unit 14 causes the constraint condition calculation unit 12 to output the most recent set-direction displacement amount candidates as the amounts of displacement of the bridge 30 (step A7).

### Effects of Embodiment

As described above, the specific parameter is updated until the difference between the irradiation-direction displacement data candidate and the observed irradiation-direction displacement data is sufficiently small, and then the most recent set-direction displacement amount candidates dx′ and dz′ are output as the amounts of displacement dx and dz of the bridge 30. In the present example embodiment, the amounts of displacement of the bridge 30 in the bridge axis direction and the vertical direction can be calculated using only irradiation-direction displacement data observed by one satellite 20. The amounts of displacement dx and dz of the bridge 30 output in this manner are highly accurate values due to matching the observed irradiation-direction displacement data.

Note that in the above example, the target object is the bridge 30, but is not limited to this. The target object may be a structure other than a bridge. Examples of structures other than a bridge include structures that are elongated in one direction.

### [Program]

The program in the example embodiment need only be a program that causes a computer to execute steps A1 to A7 shown in FIG. 7. The information processing apparatus 10 and the information processing method can be realized, by this program being installed on a computer and executed. In this case, a processor of the computer performs processing while functioning as the data acquisition unit 11, the constraint condition calculation unit 12, the displacement calculation unit 13, the parameter update unit 14 and the evaluation unit 15. Examples of the computer include a general-purpose PC, server computer, as well as a smartphone and a tablet-type terminal device.

The program in the example embodiment may also be executed by a computer system constructed from a plurality of computers. In this case, for example, each computer may function as one of the data acquisition unit 11, the constraint condition calculation unit 12, the displacement calculation unit 13, the parameter update unit 14 and the evaluation unit 15.

### [Physical Configuration]

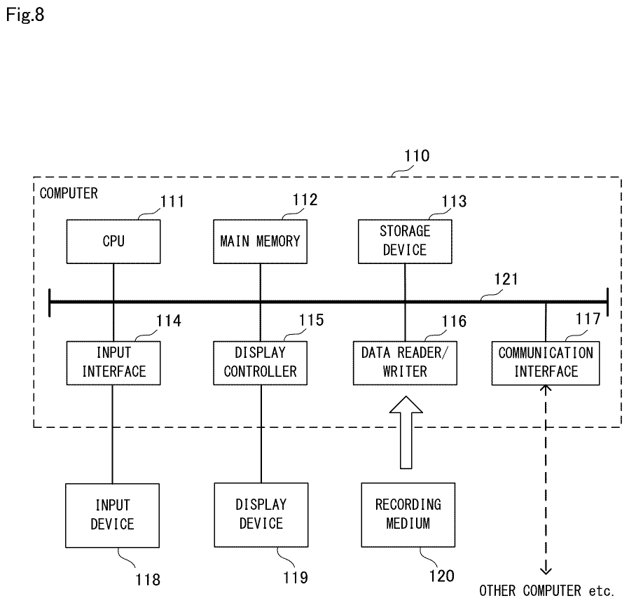

Here, a computer that realizes the information processing apparatus10 by executing the program will be described with reference to FIG. 8. FIG. 8 is a block diagram illustrating an example of a computer that realizes the information processing apparatus.

As illustrated in FIG. 8, a computer 110 includes a CPU 111, a main memory 112, a storage device 113, an input interface 114, a display controller 115, a data reader/writer 116, and a communication interface 117. These units are connected via a bus 121 so as to be able to perform data communication with each other.

the computer 110 may include a GPU (Graphics Processing Unit) or a FPGA (Field-Programmable Gate Array) in addition to the CPU 111 or instead of the CPU 111. In this case, the GPU or the FPGA may execute the program.

The CPU 111 loads programs (codes) according to the present example embodiment stored in the storage device 113 to the main memory 112, and executes the programs in a predetermined order to perform various kinds of calculations. The main memory 112 is typically a volatile storage device such as a DRAM (Dynamic Random Access Memory).

Also, the program according to the present example embodiment is provided in the state of being stored in a computer-readable recording medium 120. Note that programs according to the present example embodiment may be distributed on the Internet that is connected via the communication interface 117.

Specific examples of the storage device 113 include a hard disk drive, and a semiconductor storage device such as a flash memory. The input interface 114 mediates data transmission between the CPU 111 and an input device 118 such as a keyboard or a mouse. The display controller 115 is connected to a display device 119 and controls the display of the display device 119.

The data reader/writer 116 mediates data transmission between the CPU 111 and the recording medium 120, reads out programs from the recording medium 120, and writes the results of processing performed by the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

Note that the information processing apparatus can also be realized by using hardware (for example, electronic circuits) corresponding to the units, in place of a computer that has programs installed therein. Furthermore, a configuration may also be adopted in which a portion of the information processing apparatus is realized by programs, and the remaining portion of the information processing apparatus is realized by hardware. In the example embodiment, the computer is not limited to the computer illustrated in FIG. 7.

One or all of the above-described example embodiments can be expressed as, but are not limited to, Supplementary Note 1 to Supplementary Note 15 described below.

### (Supplementary Note 1)

An information processing apparatus comprising:
a data acquisition unit configured to acquire irradiation-direction displacement data that was generated by irradiating a target object with radio waves from a flying object and indicates an amount of displacement of the target object in an irradiation direction of the radio waves;
a constraint condition calculation unit configured to, using a constraint condition defining a relationship between a specific parameter and an amount of displacement of the target object in a set direction, calculate an amount of displacement of the target object that satisfies the constraint condition as a set-direction displacement amount candidate;
a displacement calculation unit configured to calculate an irradiation-direction displacement data candidate by applying the calculated set-direction displacement amount candidate to an expression showing a relationship between the irradiation-direction displacement data and the amount of displacement of the target object in the set direction; and
a parameter update unit configured to update the specific parameter using a difference between the calculated irradiation-direction displacement data candidate and the acquired irradiation-direction displacement data.

### (Supplementary Note 2)

The information processing apparatus according to supplementary note 1, further comprising:
an evaluation unit configured to evaluate the difference between the calculated irradiation-direction displacement data candidate and the acquired irradiation-direction displacement data,
wherein the parameter update unit updates the specific parameter based on the evaluation.

### (Supplementary Note 3)

The information processing apparatus according to supplementary note 2,
wherein the calculation of the set-direction displacement amount candidate by the constraint condition calculation unit, the calculation of the irradiation-direction displacement data candidate by the displacement calculation unit, and the updating of the specific parameter by the parameter update unit are repeatedly executed until the evaluation performed by the evaluation unit satisfies a set condition, and
the constraint condition calculation unit outputs, as the amount of displacement of the target object, the set-direction displacement amount candidate calculated using the specific parameter when the evaluation satisfied the set condition.

### (Supplementary Note 4)

The information processing apparatus according to supplementary note 2,
wherein the data acquisition unit acquires the irradiation-direction displacement data for each of a plurality of reflection points on the target object,
the constraint condition calculation unit calculates the set-direction displacement amount candidate for each of the reflection points,
the displacement calculation unit calculates the irradiation-direction displacement data candidate for each of the reflection points, and
the evaluation unit performs the evaluation using the difference for each of the reflection points.

### (Supplementary Note 5)

The information processing apparatus according to supplementary note 1,
wherein the target object is a bridge, and
there are a plurality of the set directions, including a bridge axis direction and a width direction of the bridge.

### (Supplementary Note 6)

An information processing method comprising:
a data acquisition step of acquiring irradiation-direction displacement data that was generated by irradiating a target object with radio waves from a flying object and indicates an amount of displacement of the target object in an irradiation direction of the radio waves;
a constraint condition calculation step of, using a constraint condition defining a relationship between a specific parameter and an amount of displacement of the target object in a set direction, calculating an amount of displacement of the target object that satisfies the constraint condition as a set-direction displacement amount candidate;
a displacement calculation step of calculating an irradiation-direction displacement data candidate by applying the calculated set-direction displacement amount candidate to an expression showing a relationship between the irradiation-direction displacement data and the amount of displacement of the target object in the set direction; and
a parameter update step of updating the specific parameter using a difference between the calculated irradiation-direction displacement data candidate and the acquired irradiation-direction displacement data.

### (Supplementary Note 7)

The information processing method according to supplementary note 6, further comprising:
an evaluation step of evaluating the difference between the calculated irradiation-direction displacement data candidate and the acquired irradiation-direction displacement data,
wherein in the parameter update step, the specific parameter is updated based on the evaluation.

### (Supplementary Note 8)

The information processing method according to supplementary note 7,
wherein the calculation of the set-direction displacement amount candidate in the constraint condition calculation step, the calculation of the irradiation-direction displacement data candidate in the displacement calculation step, and the updating of the specific parameter in the parameter update step are repeatedly executed until the evaluation performed in the evaluation step satisfies a set condition, and
in the constraint condition calculation step, the set-direction displacement amount candidate calculated using the specific parameter when the evaluation satisfied the set condition is output as the amount of displacement of the target object.

### (Supplementary Note 9)

The information processing method according to supplementary note 7,
wherein in the data acquisition step, the irradiation-direction displacement data is acquired for each of a plurality of reflection points on the target object,
in the constraint condition calculation step, the set-direction displacement amount candidate is calculated for each of the reflection points,
in the displacement calculation step, the irradiation-direction displacement data candidate is calculated for each of the reflection points, and
in the evaluation step, the evaluation is performed using the difference for each of the reflection points.

### (Supplementary Note 10)

The information processing method according to supplementary note 6,
wherein the target object is a bridge, and
there are a plurality of the set directions, including a bridge axis direction and a width direction of the bridge.

### (Supplementary Note 11)

A computer-readable recording medium that includes a program recorded thereon, the program including instructions that causes a computer to carry out:
a data acquisition step of acquiring irradiation-direction displacement data that was generated by irradiating a target object with radio waves from a flying object and indicates an amount of displacement of the target object in an irradiation direction of the radio waves;
a constraint condition calculation step of, using a constraint condition defining a relationship between a specific parameter and an amount of displacement of the target object in a set direction, calculating an amount of displacement of the target object that satisfies the constraint condition as a set-direction displacement amount candidate;
a displacement calculation step of calculating an irradiation-direction displacement data candidate by applying the calculated set-direction displacement amount candidate to an expression showing a relationship between the irradiation-direction displacement data and the amount of displacement of the target object in the set direction; and
a parameter update step of updating the specific parameter using a difference between the calculated irradiation-direction displacement data candidate and the acquired irradiation-direction displacement data.

### (Supplementary Note 12)

The computer-readable recording medium according to supplementary note 11,
wherein the program further includes instructions that causes the computer to carry out:
an evaluation step of evaluating the difference between the calculated irradiation-direction displacement data candidate and the acquired irradiation-direction displacement data, and
in the parameter update step, the specific parameter is updated based on the evaluation.

### (Supplementary Note 13)

The computer-readable recording medium according to supplementary note 12,
wherein the program repeatedly executes the calculation of the set-direction displacement amount candidate in the constraint condition calculation step, the calculation of the irradiation-direction displacement data candidate in the displacement calculation step, and the updating of the specific parameter in the parameter update step until the evaluation performed in the evaluation step satisfies a set condition, and
in the constraint condition calculation step, the program outputs, as the amount of displacement of the target object, the set-direction displacement amount candidate calculated using the specific parameter when the evaluation satisfied the set condition.

### (Supplementary Note 14)

The computer-readable recording medium according to supplementary note 12,
wherein in the data acquisition step, the program acquires the irradiation-direction displacement data for each of a plurality of reflection points on the target object,
in the constraint condition calculation step, the program calculates the set-direction displacement amount candidate for each of the reflection points,
in the displacement calculation step, the program calculates the irradiation-direction displacement data candidate for each of the reflection points, and
in the evaluation step, the program performs the evaluation using the difference for each of the reflection points.

### (Supplementary Note 15)

The computer-readable recording medium according to supplementary note 11,
wherein the target object is a bridge, and
there are a plurality of the set directions, including a bridge axis direction and a width direction of the bridge.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to enable calculation of an amount of displacement in a direction corresponding to the analysis target using only one flying object. The present disclosure is useful, for example, in a system that analyzes infrastructure structures.

REFERENCE SIGNS LIST

| | |
|---|---|
| 10 | Information processing apparatus |
| 11 | Data acquisition unit |
| 12 | Constraint condition calculation unit |
| 13 | Displacement calculation unit |
| 14 | Parameter update unit |
| 15 | Evaluation unit |
| 20 | Satellite |
| 21 | Database |
| 30 | Bridge |
| 40 | Terminal device |
| 110 | Computer |
| 111 | CPU |
| 112 | Main memory |
| 113 | Storage device |
| 114 | Input interface |
| 115 | Display controller |
| 116 | Data reader/writer |
| 117 | Communication interface |
| 118 | Input device |
| 119 | Display device |
| 120 | Recording medium |
| 121 | Bus |

What is claimed is:

1. An information processing apparatus comprising:
at least one memory storing instructions; and
at least one processor configured to execute the instructions to:
acquire irradiation-direction displacement data that was generated by irradiating a target object with radio waves from a flying object and indicates an amount of displacement of the target object in an irradiation direction of the radio waves;
calculate, using a constraint condition defining a relationship between a specific parameter and an amount of displacement of the target object in a set direction, an amount of displacement of the target object that satisfies the constraint condition as a set-direction displacement amount candidate;
calculate an irradiation-direction displacement data candidate by applying the calculated set-direction displacement amount candidate to an expression showing a relationship between the irradiation-direction displacement data and the amount of displacement of the target object in the set direction; and
update the specific parameter using a difference between the calculated irradiation-direction displacement data candidate and the acquired irradiation-direction displacement data.

2. The information processing apparatus according to claim 1, wherein
the one or more processors further evaluates the difference between the calculated irradiation-direction displacement data candidate and the acquired irradiation-direction displacement data; and
updates the specific parameter based on the evaluation.

3. The information processing apparatus according to claim 2,
wherein the calculation of the set-direction displacement amount candidate, the calculation of the irradiation-direction displacement data candidate, and the updating of the specific parameter are repeatedly executed until the evaluation satisfies a set condition, and
the one or more processors outputs, as the amount of displacement of the target object, the set-direction displacement amount candidate calculated using the specific parameter when the evaluation satisfied the set condition.

4. The information processing apparatus according to claim 2, wherein
the one or more processors acquires the irradiation-direction displacement data for each of a plurality of reflection points on the target object;
calculates the set-direction displacement amount candidate for each of the reflection points;
calculates the irradiation-direction displacement data candidate for each of the reflection points; and
performs the evaluation using the difference for each of the reflection points.

5. The information processing apparatus according to claim 1,
wherein the target object is a bridge, and
there are a plurality of the set directions, including a bridge axis direction and a width direction of the bridge.

6. An information processing method comprising:
acquiring irradiation-direction displacement data that was generated by irradiating a target object with radio waves from a flying object and indicates an amount of displacement of the target object in an irradiation direction of the radio waves;
calculating, using a constraint condition defining a relationship between a specific parameter and an amount of displacement of the target object in a set direction, an amount of displacement of the target object that satisfies the constraint condition as a set-direction displacement amount candidate;
calculating an irradiation-direction displacement data candidate by applying the calculated set-direction displacement amount candidate to an expression showing a relationship between the irradiation-direction displacement data and the amount of displacement of the target object in the set direction; and
updating the specific parameter using a difference between the calculated irradiation-direction displacement data candidate and the acquired irradiation-direction displacement data.

7. The information processing method according to claim 6, further comprising:
evaluating the difference between the calculated irradiation-direction displacement data candidate and the acquired irradiation-direction displacement data,
wherein in the parameter update, the specific parameter is updated based on the evaluation.

8. The information processing method according to claim 7,
wherein the calculation of the set-direction displacement amount candidate, the calculation of the irradiation-direction displacement data candidate, and the updating of the specific parameter are repeatedly executed until the evaluation satisfies a set condition, and
in the constraint condition calculation, the set-direction displacement amount candidate calculated using the specific parameter when the evaluation satisfied the set condition is output as the amount of displacement of the target object.

9. The information processing method according to claim 7,
wherein in the data acquisition step, the irradiation-direction displacement data is acquired for each of a plurality of reflection points on the target object,
in the constraint condition calculation, the set-direction displacement amount candidate is calculated for each of the reflection points,
in the displacement calculation, the irradiation-direction displacement data candidate is calculated for each of the reflection points, and
in the evaluation, the evaluation is performed using the difference for each of the reflection points.

10. The information processing method according to claim 6,
wherein the target object is a bridge, and
there are a plurality of the set directions, including a bridge axis direction and a width direction of the bridge.

11. A non-transitory computer-readable recording medium that includes a program recorded thereon, the program including instructions that causes a computer to carry out:
acquiring irradiation-direction displacement data that was generated by irradiating a target object with radio waves from a flying object and indicates an amount of displacement of the target object in an irradiation direction of the radio waves;
calculating, using a constraint condition defining a relationship between a specific parameter and an amount of displacement of the target object in a set direction, an amount of displacement of the target object that satisfies the constraint condition as a set-direction displacement amount candidate;
calculating an irradiation-direction displacement data candidate by applying the calculated set-direction displacement amount candidate to an expression showing a relationship between the irradiation-direction displacement data and the amount of displacement of the target object in the set direction; and
updating the specific parameter using a difference between the calculated irradiation-direction displacement data candidate and the acquired irradiation-direction displacement data.

12. The non-transitory computer-readable recording medium according to claim 11,
wherein the program further includes instructions that causes the computer to carry out:
evaluating the difference between the calculated irradiation-direction displacement data candidate and the acquired irradiation-direction displacement data, and
in the parameter update, the specific parameter is updated based on the evaluation.

13. The non-transitory computer-readable recording medium according to claim 12,
wherein the program repeatedly executes the calculation of the set-direction displacement amount candidate, the calculation of the irradiation-direction displacement data candidate, and the updating of the specific parameter until the evaluation performed in the evaluation step satisfies a set condition, and
in the constraint condition calculation, the program outputs, as the amount of displacement of the target object, the set-direction displacement amount candidate calculated using the specific parameter when the evaluation satisfied the set condition.

14. The non-transitory computer-readable recording medium according to claim 12,
wherein in the data acquisition, the program acquires the irradiation-direction displacement data for each of a plurality of reflection points on the target object,
in the constraint condition calculation, the program calculates the set-direction displacement amount candidate for each of the reflection points,
in the displacement calculation, the program calculates the irradiation-direction displacement data candidate for each of the reflection points, and
in the evaluation, the program performs the evaluation using the difference for each of the reflection points.

15. The non-transitory computer-readable recording medium according to claim 11,
wherein the target object is a bridge, and
there are a plurality of the set directions, including a bridge axis direction and a width direction of the bridge.
